(19) United States
(12) Patent Application Publication
(10) Pub. No.: US 2026/0103059 A1
(43) Pub. Date: Apr. 16, 2026

(54) AUTOMOTIVE CANOPY DOOR

(71) Applicant: RSI North America, Inc., Fort Worth, TX (US)

(72) Inventor: Marius DREYER, Fort Worth, TX (US)

(73) Assignee: RSI North America, Inc., Fort Worth, TX (US)

(21) Appl. No.: 19/354,642

(22) Filed: Oct. 9, 2025

Related U.S. Application Data
(63) Continuation of application No. PCT/US2024/024252, filed on Apr. 12, 2024.
Application No. PCT/US2024/024252 is a continuation-in-part of application No. 18/134,946, filed on Apr. 14, 2023.

(51) Int. Cl. B60J 5/04; B60J 7/16; B60R 11/00; B60R 11/06

(52) U.S. Cl. CPC B60J 5/0498; B60J 7/1607; B60R 11/06; B60R 2011/0021

(57) ABSTRACT

An automotive canopy door includes an external panel having a first side and a second side and an internal panel having a first side and a second side. The first side of the internal panel is coupled to the second side of the external panel, and the internal panel includes a support structure located adjacent to a support aperture.

### PRIORITY CLAIM

This application is a continuation of International Patent Application No. PCT/US2024/024252 filed on Apr. 12, 2024, which claims priority to and the benefit of U.S. patent application Ser. No. 18/134,946, filed Apr. 14, 2023, the entirety of which is herein incorporated by reference.

### BACKGROUND

The present disclosure generally relates to an automotive canopy door. Typically, a vehicle bed comprises a generally flat surface located behind a vehicle cabin and may typically have sidewalls and a rear tailgate. The vehicle bed may be used for a number of utility purposes, including transporting cargo. Further, a vehicle bed may include a canopy, or cap, creating an enclosure on the vehicle bed. The vehicle canopy may protect cargo from the elements and prevent cargo from falling off of the vehicle bed when the vehicle is moving. Additionally, a vehicle canopy could be useful for providing a compartment for sleeping during overlanding, which consists of overland travel to remote destinations.

### SUMMARY

In light of the disclosure herein and without limiting the disclosure in any way, in a first aspect of the present disclosure, which may be combined with any other aspect listed herein unless specified otherwise, an automotive canopy door includes an external panel having a first side and a second side, and an internal panel having a first side and a second side. The first side of the internal panel is coupled to the second side of the external panel, and the internal panel includes a support structure located adjacent to a support aperture.

In accordance with a second aspect of the present disclosure, which may be used in combination with any other aspect listed herein unless stated otherwise, the internal panel includes a perimeter structure.

In accordance with a third aspect of the present disclosure, which may be used in combination with any other aspect listed herein unless stated otherwise, the perimeter structure includes a first portion that extends outward from the first side of the internal panel, and a second portion that extends generally coplanar to the first side of the internal panel.

In accordance with a fourth aspect of the present disclosure, which may be used in combination with any other aspect listed herein unless stated otherwise, the adhesive substrate couples the first side of the internal panel to the second side of the external panel.

In accordance with a fifth aspect of the present disclosure, which may be used in combination with any other aspect listed herein unless stated otherwise, the adhesive substrate is disposed between the second portion of the perimeter structure and the second side of the external panel.

In accordance with a sixth aspect of the present disclosure, which may be used in combination with any other aspect listed herein unless stated otherwise, the first portion is configured to provide a space between the external panel and the internal panel, preventing an internal panel securing member from contacting the second side of the external panel.

In accordance with a seventh aspect of the present disclosure, which may be used in combination with any other aspect listed herein unless stated otherwise, the internal panel includes a pressure lock aperture configured to receive a pressure lock coupled to the external panel.

In accordance with an eighth aspect of the present disclosure, which may be used in combination with any other aspect listed herein unless stated otherwise, the internal panel includes a support aperture.

In accordance with a ninth aspect of the present disclosure, which may be used in combination with any other aspect listed herein unless stated otherwise, the support structure if formed by folding material from the internal panel.

In accordance with a tenth aspect of the present disclosure, which may be used in combination with any other aspect listed herein unless stated otherwise, wherein, folding the material from the internal panel to form the support structure creates the support aperture.

In accordance with an eleventh aspect of the present disclosure, which may be used in combination with any other aspect listed herein unless stated otherwise, the internal panel includes an aperture configured to receive an attachment.

In accordance with a twelfth aspect of the present disclosure, which may be used in combination with any other aspect listed herein unless stated otherwise, the aperture is a rectangular shape.

In accordance with a thirteenth aspect of the present disclosure, which may be used in combination with any other aspect listed herein unless stated otherwise, the internal panel includes a plurality of apertures. A first sub plurality of the plurality of apertures are a first shape and a second sub plurality of the plurality of apertures are a second shape. The second shape is different than the first shape.

In accordance with a fourteenth aspect of the present disclosure, which may be used in combination with any other aspect listed herein unless stated otherwise, an automotive canopy includes a top panel, a front panel, a plurality of side panels, a rear panel, and at least one door including an external panel having a first side and a second side and an internal panel having a first side and a second side. The first side of the internal panel is coupled to the second side of the external panel, and the internal panel includes a support structure located adjacent to a support aperture.

In accordance with a fifteenth aspect of the present disclosure, which may be used in combination with any other aspect listed herein unless stated otherwise, a modular kit for assembly of automotive canopy includes a top panel, a front panel, a plurality of side panels, a rear panel, and at least one door including an external panel having a first side and a second side and an internal panel having a first side and a second side. The first side of the internal panel is coupled to the second side of the external panel, and the internal panel includes a support structure located adjacent to a support aperture.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates a vehicle with an automotive canopy door, according to various examples of the present disclosure.

FIG. 2 illustrates an external panel and an internal panel of an automotive canopy door, according to various examples of the present disclosure.

FIG. 3 illustrates an external panel, an internal panel, and a removable panel of automotive canopy door, according to various examples of the present disclosure.

FIG. 4 illustrates an external panel and an internal panel of an automotive canopy door, according to various examples of the present disclosure.

FIG. 5 illustrates a cross sectional view of an internal panel of automotive canopy door, according to various examples of the present disclosure.

FIG. 6 illustrates an external panel, an internal panel, and a removable panel of an automotive canopy door in a coupled configuration, according to various examples of the present disclosure.

FIG. 7 illustrates an external panel and an internal panel of an automotive canopy door in a coupled configuration, according to various examples of the present disclosure.

FIGS. 8A-B illustrate cross sectional views an external panel, an internal panel, and a removable panel of an automotive canopy door in a coupled configuration, according to various examples of the present disclosure.

FIGS. 9A-B illustrate cross sectional views an external panel and an internal panel of an automotive canopy door in a coupled configuration, according to various examples of the present disclosure.

### DETAILED DESCRIPTION OF EXAMPLE EMBODIMENTS

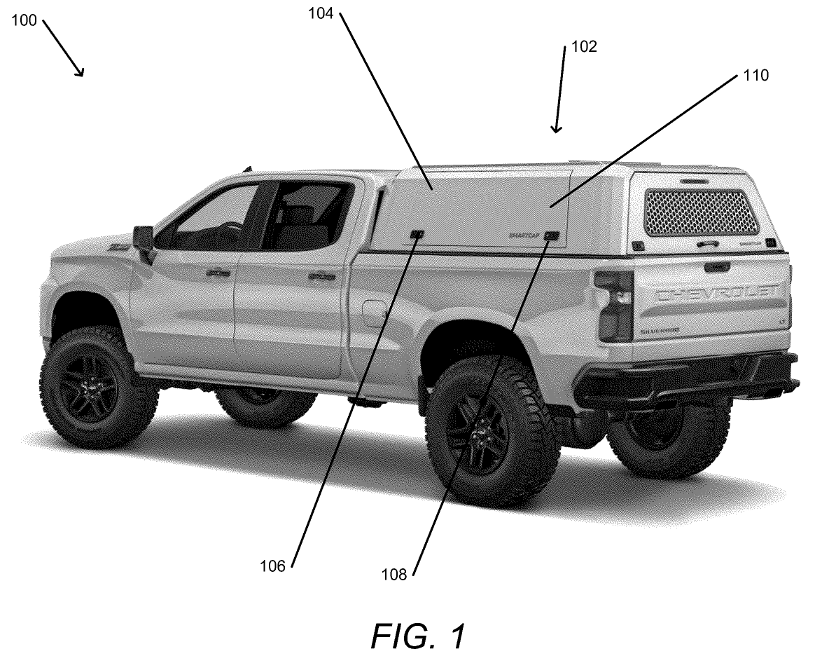

FIG. 1 illustrates a vehicle with an automotive canopy door, according to various examples of the present disclosure. The vehicle 100 includes a canopy 102. The canopy 102 includes an automotive canopy door 104 in the closed position. The automotive canopy door 104 includes an external panel 110, a first pressure lock 106, and a second pressure lock 108. In various embodiments, the number and orientation of the first pressure lock 106 and the second pressure lock 108 can be varied. In an example, the automotive canopy door 104 may include one pressure lock, such that the user would only be required to lock or unlock one pressure lock to open or close the automotive canopy door 104. In another example, the automotive canopy door 104 may include more than two pressure locks for added security. In an illustrative example, a user unlocks the first pressure lock 106 and the second pressure lock 108 to open the automotive canopy door 104 and access the vehicle bed to, for example, retrieve tools.

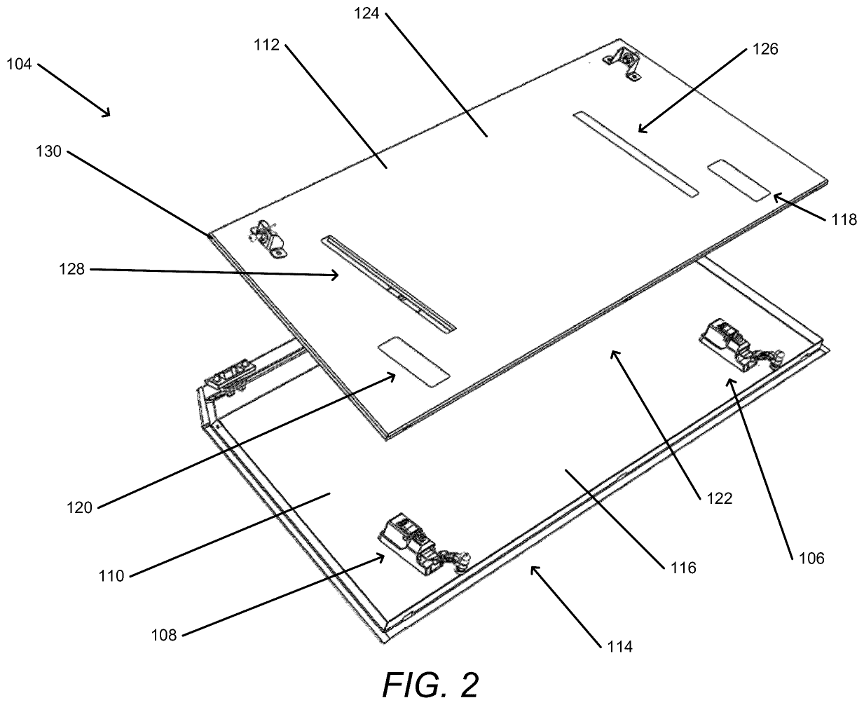

FIG. 2 illustrates an external panel and an internal panel of an automotive canopy door, according to various examples of the present disclosure. The automotive canopy door 104 includes the external panel 110 and an internal panel 112. The external panel 110 includes a first side 114 and a second side 116. In reference to FIG. 1, the external panel 110 is visible from the outside of the vehicle 100, and the first side 114 of the external panel 110 faces outward, away from the vehicle bed 100 in the closed position. In various embodiments, the first pressure lock 106 and the second pressure lock 108 extend through the first side 114 of the external panel 110 to the second side 116 of the external panel 110. Further, the first pressure lock 106 and the second pressure lock 108 extend through a first pressure lock aperture 118 and second pressure lock aperture 120 in the internal panel 112. Thus, the first pressure lock 106 and the second pressure lock 108 are accessible from inside the vehicle bed.

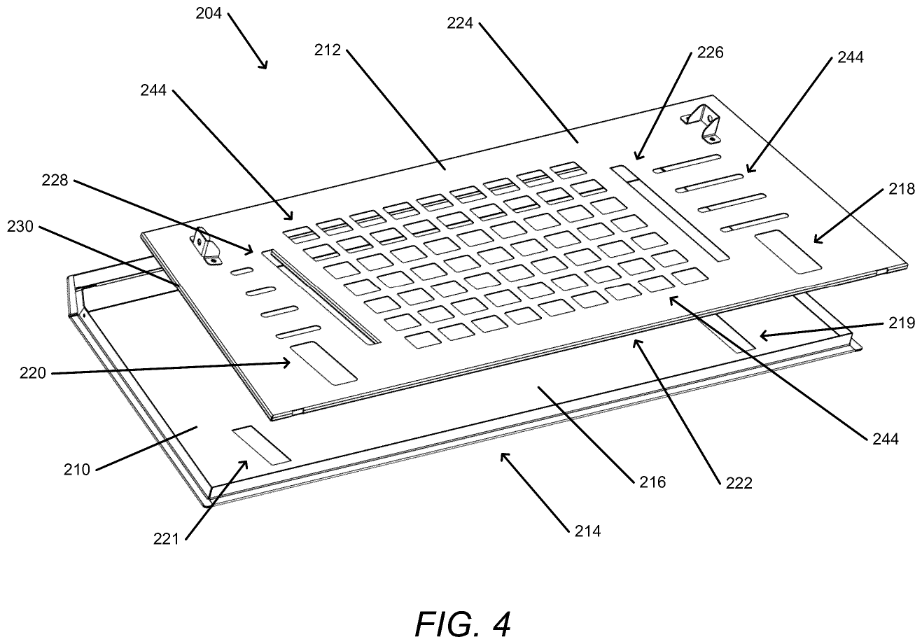

The internal panel 112 includes a first side 122 and a second side 124. The first side 122 faces outward, toward the second side 116 of the external panel 110 while the second side 124 faces inward, toward the vehicle bed. The internal panel 112 further includes a first support aperture 126, a second support aperture 128, and a perimeter structure 130. The first support aperture 126 and the second support aperture 128 are further detailed in reference to FIG. 4.

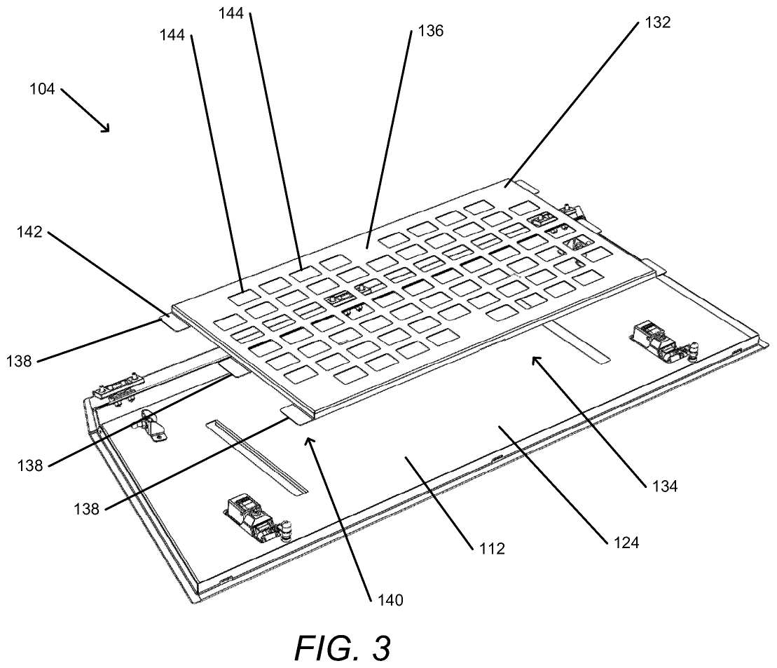

FIG. 3 illustrates an external panel, an internal panel, and a removable panel of automotive canopy door, according to various examples of the present disclosure. The automotive canopy door 104 includes the internal panel 112, as previously introduced, which includes the second side 124. The automotive canopy door 104 further includes a removable panel 132 having a first side 134 and a second side 136. The first side 134 of the removable panel 132 faces the second side 124 of the internal panel 112 and the second side 136 of the removable panel 132 faces inward, toward the bed of the vehicle.

The removable panel 132 includes a plurality of apertures 144. The plurality of apertures 144 may provide accessible attachment points for various tools. The removable panel 132 further includes a plurality of tabs 138. Each one of the plurality of tabs 138 includes a first side 140 and a second side 142. The first side 140 of each of the plurality of tabs 138 faces the second side 124 of the internal panel 112, and the second side 142 of each of the plurality of tabs 138 faces inward, toward the bed of the vehicle. The removable panel 132 is coupled to the internal panel 112. In various embodiments, an interlocking system is disposed between the first side 140 of each of the plurality of tabs 138 and the second side 124 of the internal panel 112. The interlocking system allows a user to easily remove and re-attach the removable panel 132 to the internal panel 112 of the automotive canopy door 104. In various embodiments, the interlocking system includes 3M™ Dual Lock™ Reclosable Fasteners. In many embodiments, a hook and loop system, such as Velcro, is disposed between the first side 140 of each of the plurality of tabs 138 and the second side 124 of the internal panel 112.

FIG. 4 illustrates an external panel and an internal panel of an automotive canopy door, according to various examples of the present disclosure. As introduced with FIG. 3, the automotive canopy door may include a removable panel with a plurality of apertures. Thus, the embodiment of FIG. 3 provides various options for the user. For example, if the user intends to attach tools to the plurality of apertures, the user can attach the removable panel to the automotive canopy door. A user can alternatively remove the removable panel if they do not intend to utilize the plurality of apertures. Further, the removable panel may provide added structural strength to the automotive door. However, the removable panel may add weight to the automotive canopy door. In other embodiments, the automotive canopy door may not include a removable panel and the plurality of apertures may be integrated into the internal panel. With such embodiment, the functionality of the plurality of apertures is provided without the additional weight of the removable panel, thereby reducing the overall weight of the automotive canopy door. Even if a user does not intend to use the plurality of apertures to store tools, the plurality of apertures provide weight savings over the embodiment of FIG. 4 without the removable panel. However, the embodiment of FIG. 4 provides less flexibility, and the structural strength of the automotive canopy door may be less than with the removable panel.

For example, referring to FIG. 4, the automotive canopy door 204 includes an external panel 210 and an internal panel 212. The external panel 210 includes a first side 214 and a second side 216. In reference to FIG. 1, the external panel 210 is visible from the outside of the vehicle 100, and the first side 214 of the external panel 210 faces outward, away from the vehicle bed 100 in the closed position. In various embodiments, the internal panel 212 includes a first pressure lock aperture 218 and a second pressure lock aperture 220. The external panel 210 includes a third pressure lock aperture 219 and a fourth pressure lock aperture 221. The first pressure lock aperture 218 correspond to the third pressure lock aperture 219. The second pressure lock aperture 220 corresponds to the fourth pressure lock aperture 221. Thus, a first pressure lock and a second pressure lock may extend through the respective apertures to be accessible from inside the vehicle bed as well as outside of the vehicle bed.

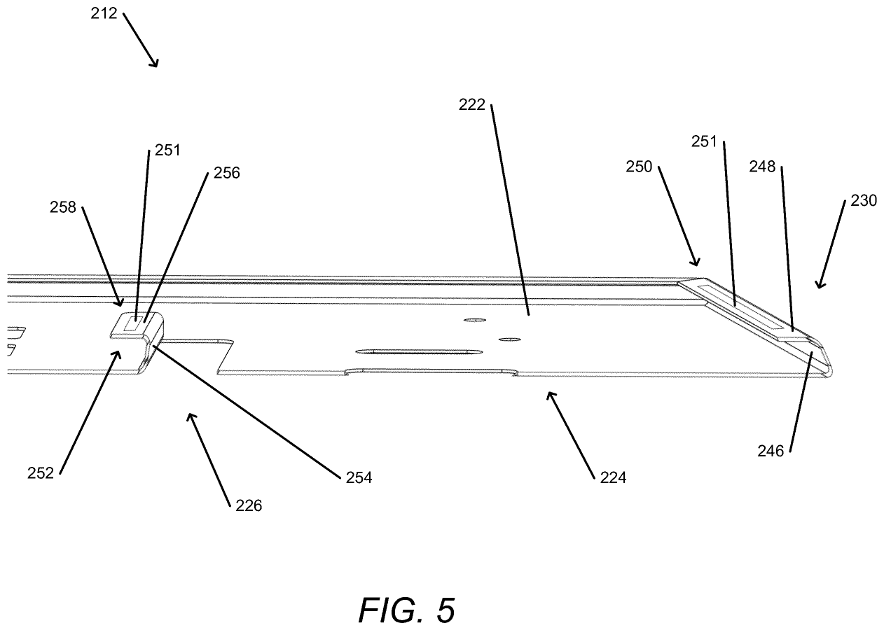

The internal panel 212 includes a first side 222 and a second side 224. The first side 222 faces outward, toward the second side 216 of the external panel 210 while the second side 224 faces inward, toward the vehicle bed. The internal panel 212 further includes a first support aperture 226, a second support aperture 228, and a perimeter structure 230. The first support aperture 226 and the second support aperture 228 are further detailed in reference to FIG. 5.

The internal panel 212 may further include a plurality of apertures 244. Similar to the plurality of apertures 144 in the removable panel 132 in FIG. 3, the plurality of apertures 244 may provide accessible attachment points for various tools. The plurality of apertures 244 may be any number of shapes. Further, as shown in FIG. 4, the plurality of apertures 244 can be different shapes to accommodate different attachment points for a variety of tools.

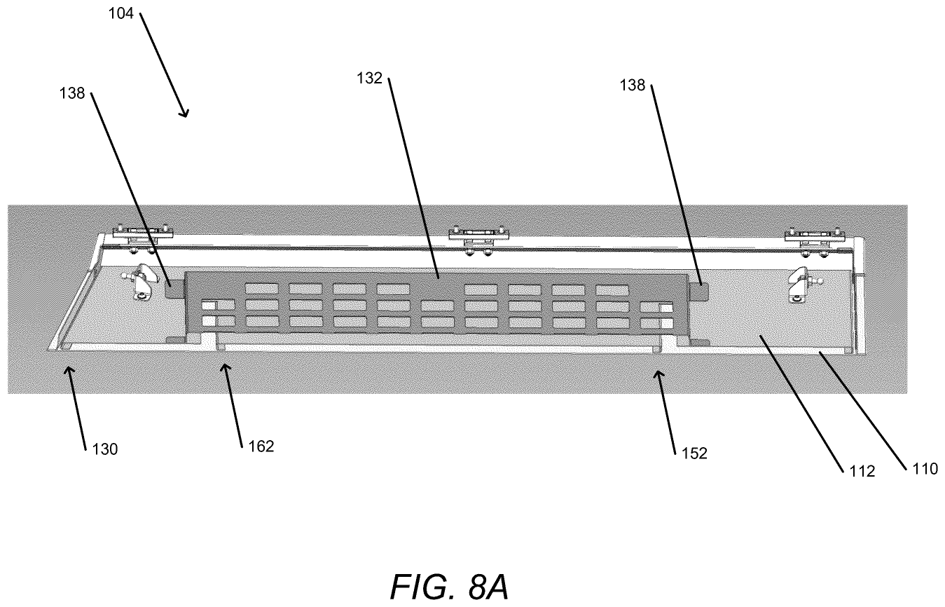

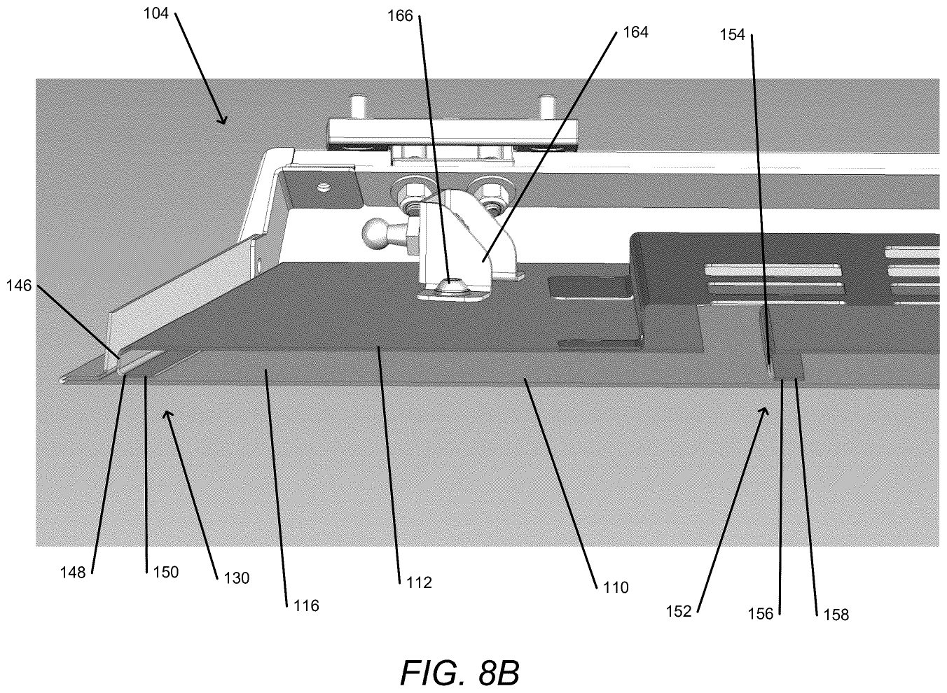

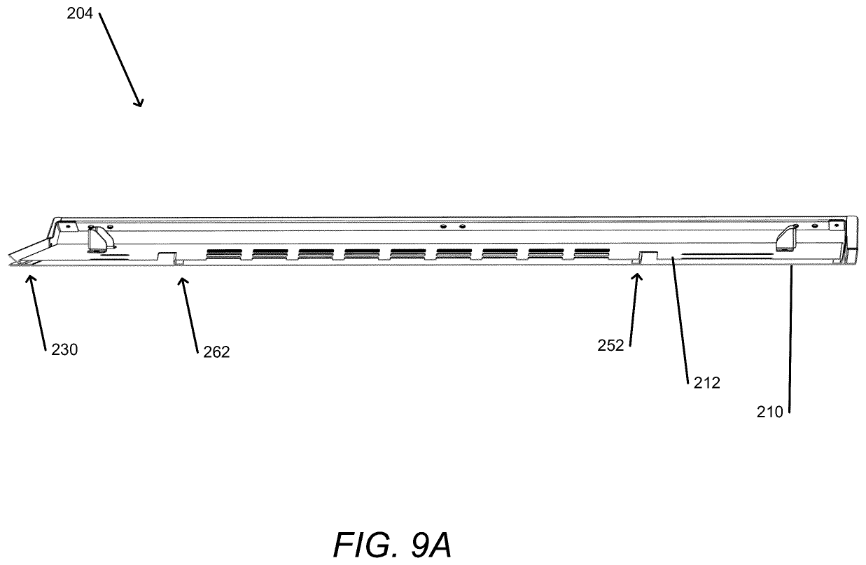

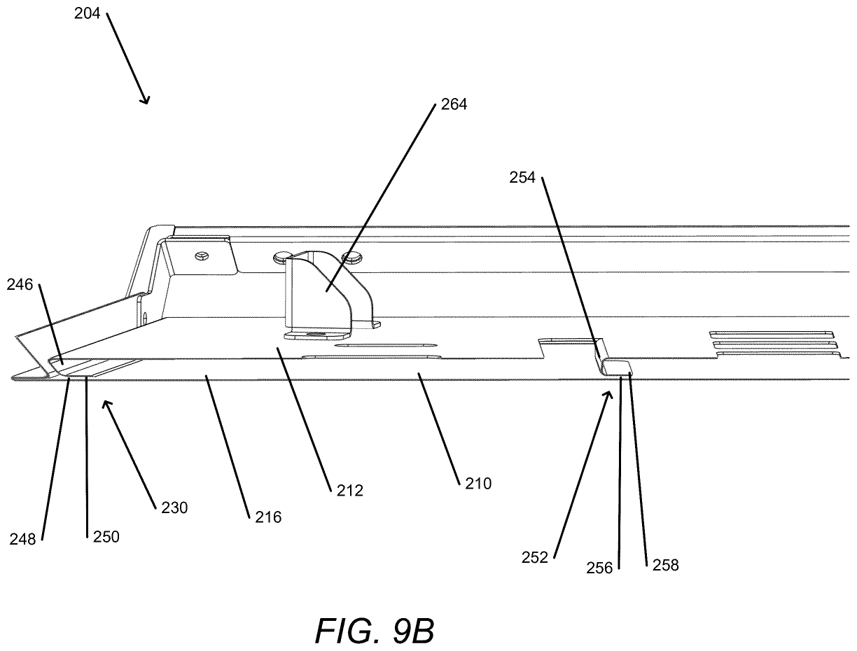

FIG. 5 illustrates a cross sectional view of an internal panel of automotive canopy door, according to various examples of the present disclosure. It should be appreciated that the internal panel 212 includes similar features with similar functions in the embodiments as described in reference to FIG. 1 to 4. The internal panel 212 includes the first side 222 and the second side 224. The internal panel 212 further includes a perimeter structure 230, a first support aperture 226, and a second support aperture 228 (not shown). The perimeter structure 230 includes a first portion 246 and a second portion 248 having a first side 250. The first side 250 includes an adhesive substrate 251, which is further described in reference to FIGS. 8A to 9B. In many embodiments, the first portion 246 extends outward from the first side 222 of the internal panel 212, and the second portion 248 extends generally coplanar to the first side 222 of the internal panel 212. As shown in FIG. 4, the first portion 246 extends from the first side 222 of the internal panel 212 at an acute angle. In various embodiments, this angle can be varied.

The internal panel 212 may further include a first support aperture 226. A first support structure 252 is located adjacent to the first support aperture 226. The first support structure 252 includes a first portion 254 and a second portion 256 having a first side 258. The first side 258 includes an adhesive substrate 251, which is further described in reference to FIGS. 8A to 9B. In many embodiments, the first portion 254 extends outward from the first side 222 of the internal panel 212, and the second portion 256 extends generally coplanar to the first side 222 of the internal panel 212. In many embodiments, the first portion 254 extends generally perpendicular to the first side 222 of the internal panel 212. In various embodiments, the first support structure 252 is comprised of material from the internal panel 212. In an example, the internal panel 212 is made from metal. During manufacture, a portion of the metal is cut from the internal panel 212 and folded, thereby creating the first support aperture 226 and the first support structure 252.

While the first support aperture 226 is used consistently in reference to the figures, the first support aperture 226 itself does not assist with support. Rather, the aperture is referred to as a first support aperture 226 based on its relationship with the first support structure 252. Further, the relationship between the first support aperture 226 and the first support structure 252 is advantageous because the material cut from the internal panel 212 forms the first support aperture 226 and the first support structure 252, leading to an increase in strength and rigidity without requiring additional parts to be added to the internal panel 212. FIG. 5 describes the first support structure 252 and the first support aperture 226. However, the first support structure 252 and the first support aperture 226 are analogous, in both structure and function, to the second support structure and the second support aperture. Thus, the description of the first support structure 252 and the first support aperture 226 apply equally to the second support aperture 228 and the second support structure 262.

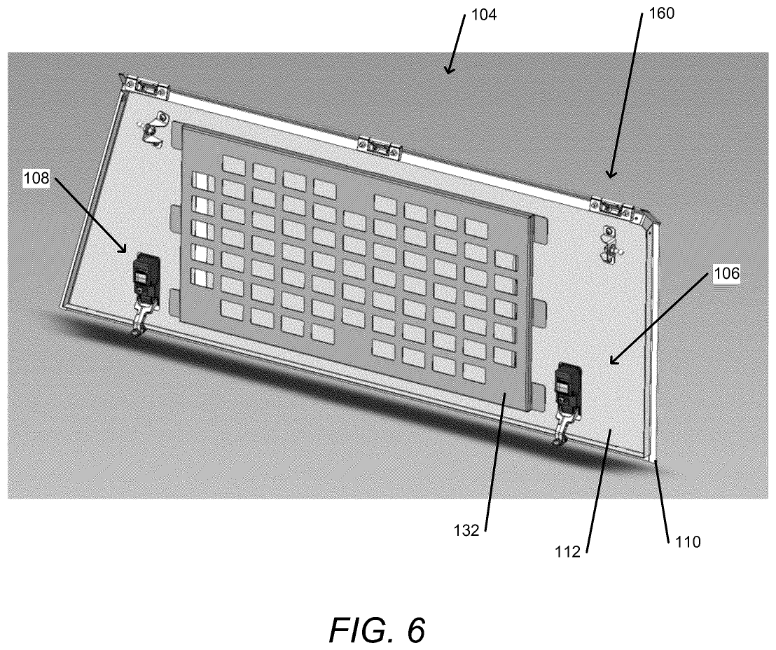

FIG. 6 illustrates an external panel, an internal panel, and a removable panel of an automotive canopy door in a coupled configuration, according to various examples of the present disclosure. In FIG. 6, the external panel 110 is coupled to the internal panel 112, which is coupled to the removable panel 132. In various embodiments, the external panel 110 includes at least one hinge 160, which attached the automotive canopy door 104 to the canopy. Further, as previously introduced, the first pressure lock 106 and the second pressure lock 108 extend through the external panel 110 and the internal panel 112, providing accessibility from the inside of a canopy. In an example, a user may unlock the first pressure lock 106 and the second pressure 108 from inside the canopy and open the automotive canopy door 104.

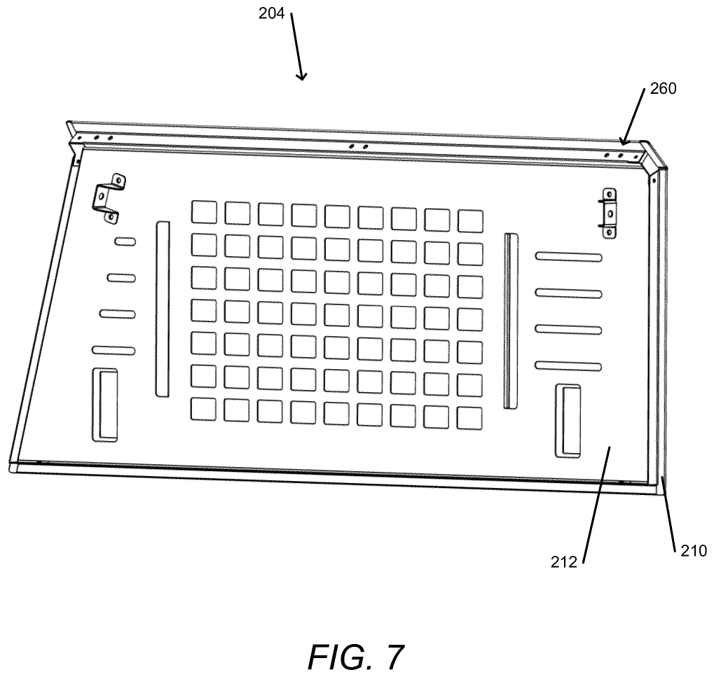

FIG. 7 illustrates an external panel and an internal panel of an automotive canopy door in a coupled configuration, according to various examples of the present disclosure. In FIG. 4, the external panel 210 is coupled to the internal panel 212. In various embodiments, the external panel 210 includes at least one hinge (not show) which couples to a plurality of apertures 260. The hinge attaches the automotive canopy door 204 to the canopy. Further, as previously introduced, a first pressure lock and a second pressure lock may extend through the external panel 210 and the internal panel 212, providing accessibility from the inside of a canopy. In an example, a user may unlock the first pressure lock 206 and the second pressure 208 from inside the canopy and open the automotive canopy door 204.

FIGS. 8A-B illustrate cross sectional views an external panel, an internal panel, and a removable panel of an automotive canopy door in a coupled configuration, according to various examples of the present disclosure. In FIG. 8A, the external panel 110 is coupled to the internal panel 112. In various embodiments, the first support structure 152, a second support structure 162, and the perimeter structure 130 of the internal panel 112 couple to the external panel 110. Further, the internal panel 112 is coupled to the removable panel 132 via a plurality of tabs 138.

FIG. 8B illustrates an exploded view of FIG. 8A. In a number of embodiments, the perimeter structure 130 includes the first portion 146 and the second portion 148 having a first side 150. The internal panel 112 is coupled to the external panel 110. In various embodiments, an adhesive substrate (not shown) is disposed between the first side 150 of the second portion 148 of the perimeter structure 130 and the second side 116 of the external panel 110. In many embodiments, an adhesive substrate (not shown) is also disposed between the first side 158 of the second portion 156 of the first support structure 152 and the second side 116 of the external panel 110. In an example, the adhesive substrate is Very High Bond™ Tape (“VHB Tape™”).

In a number of embodiments, a component 164 is secured to the internal panel 112 via a securing member 166, which extends through the internal panel 112. In an example, the first portion 154 of the first support structure 152 and the first portion 146 of the perimeter structure 130 are configured such that the securing member 166 does not contact the second side 116 of the external panel 110.

FIGS. 9A-B illustrate cross sectional views an external panel and an internal panel of an automotive canopy door in a coupled configuration, according to various examples of the present disclosure. In FIG. 9A, the external panel 210 is coupled to the internal panel 212. In various embodiments, the first support structure 252, the second support structure 262, and the perimeter structure 230 of the internal panel 212 couple to the external panel 210.

FIG. 9B illustrates an exploded view of FIG. 5A. In a number of embodiments, the perimeter structure 230 includes the first portion 246 and the second portion 248 having a first side 250. The internal panel 212 is coupled to the external panel 210. In various embodiments, an adhesive substrate (not shown) is disposed between the first side 250 of the second portion 248 of the perimeter structure 230 and the second side 216 of the external panel 210. In many embodiments, an adhesive substrate (not shown) is also disposed between the first side 258 of the second portion 256 of the first support structure 252 and the second side 216 of the external panel 210. In an example, the adhesive substrate is Very High Bond™ Tape (“VHB Tape™”).

In a number of embodiments, a component 264 is secured to the internal panel 212 via a securing member (not shown), which extends through the internal panel 212. In an example, the first portion 254 of the first support structure 252 and the first portion 246 of the perimeter structure 230 are configured such that the securing member does not contact the second side 216 of the external panel 210.

Although the automotive canopy door has been described in certain specific aspects, many additional modifications and variations would be apparent to those skilled in the art. In particular, any of the various processes described above can be performed in alternative sequences and/or in parallel in order to achieve similar results in a manner that is more appropriate to the requirements of a specific application. It is therefore to be understood that the present disclosure can be practiced otherwise than specifically described without departing from the scope and spirit of the present embodiments. Thus, embodiments of the present invention should be considered in all respects as illustrative and not restrictive. It will be evident to the annotator skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled annotator, except where expressly required. Accordingly, the scope of the invention should be determined not by the embodiments illustrated, but by the appended claims and their equivalents.

The invention is claimed as follows:

1. An automotive canopy door, comprising:
an external panel having a first side and a second side;
an internal panel having a first side and a second side, wherein the first side of the internal panel is coupled to the second side of the external panel, and wherein the internal panel comprises a support structure located adjacent to a support aperture.

2. The automotive canopy door of claim 1, wherein the internal panel comprises a perimeter structure.

3. The automotive canopy door of claim 2, wherein the perimeter structure comprises:
a first portion that extends outward from the first side of the internal panel; and
a second portion that extends generally coplanar to the first side of the internal panel.

4. The automotive canopy door of claim 3, wherein an adhesive substrate couples the first side of the internal panel to the second side of the external panel.

5. The automotive canopy door of claim 4, wherein the adhesive substrate is disposed between the second portion of the perimeter structure and the second side of the external panel.

6. The automotive canopy door of claim 3, wherein the first portion is configured to provide a space between the external panel and the internal panel, preventing an internal panel securing member from contacting the second side of the external panel.

7. The automotive canopy door of claim 2, wherein the internal panel comprises a pressure lock aperture configured to receive a pressure lock coupled to the external panel.

8. The automotive canopy door of claim 1, wherein the support structure comprises:
a first portion that extends outward from the first side of the internal panel; and
a second portion that extends generally coplanar to the first side of the internal panel.

9. The automotive canopy door of claim 1, wherein the support structure if formed by folding material from the internal panel.

10. The automotive canopy door of claim 9, wherein, folding the material from the internal panel to form the support structure creates the support aperture.

11. The automotive canopy door of claim 2, wherein the internal panel comprises an aperture configured to receive an attachment.

12. The automotive canopy door of claim 11, wherein the aperture is a rectangular shape.

13. The automotive canopy door of claim 2, wherein the internal panel comprises a plurality of apertures, wherein a first sub plurality of the plurality of apertures are a first shape, and wherein a second sub plurality of the plurality of apertures are a second shape, different than the first shape.

14. An automotive canopy comprising:
a top panel;
a front panel;
a plurality of side panels;
a rear panel; and
at least one door, comprising:
an external panel having a first side and a second side; and
an internal panel having a first side and a second side, wherein the first side of the internal panel is coupled to the second side of the external panel, and wherein the internal panel comprises a support structure located adjacent to a support aperture.

15. A modular kit for assembly of automotive canopy comprising:
a top panel;
a front panel;
a plurality of side panels;
a rear panel; and
at least one door, comprising:
an external panel having a first side and a second side; and
an internal panel having a first side and a second side, wherein the first side of the internal panel is coupled to the second side of the external panel, and wherein the internal panel comprises a support structure located adjacent to a support aperture.
